(19) United States
(12) Patent Application Publication
(10) Pub. No.: US 2012/0124799 A1
(43) Pub. Date: May 24, 2012

(54) Self-Installed Security System

(75) Inventor: Kenneth L. Addy, Massapequa, NY (US)

(73) Assignee: Honeywell International Inc., Morristown, NJ (US)

(21) Appl. No.: 13/181,586

(22) Filed: Jul. 13, 2011

Related U.S. Application Data
(60) Provisional application No. 61/416,457, filed on Nov. 23, 2010.

(51) Int. Cl. B23P 17/00

(52) U.S. Cl. 29/407.1; 29/709

(57) ABSTRACT

A security system installation kit carries a coded designation of the characteristics of the components of the kit. An installer can use a wireless telephone, which is executing a scanning application, to sense or read the coded designation. The telephone can transmit the component parameters to an installation server. The server can transmit installation instructions back to the telephone. Those instructions can be visually or audibly presented to the installer facilitating the process. The installer, via the telephone and the server, can test the installed components for proper operation.

### CROSS-REFERENCE TO RELATED APPLICATION

This application claims the benefit of the filing date of U.S. Provisional Application Ser. No. 61/416,457 filed Nov. 23, 2010 entitled, Self-Installed Security System which is hereby incorporated herein by reference.

### FIELD

The application pertains to regional monitoring systems which provide audio, and/or visual feedback to assist an individual in making an installation. More particularly, it pertains to such systems where a cellular-type wireless telephone facilitates the process by providing audible or visual instructions to the individual.

### BACKGROUND

Traditional security systems have been professionally installed and monitored. The installation process involves configuring wired and/or wireless security sensors that are installed in a building. Since all buildings are different, the installation process is difficult to standardize in a pre-configured kit, so DIY (do-it-yourself) installation has been rarely used in the security industry.

Despite the above noted problems, there is a substantial do-it-yourself market which might respond to a product, or kit which addresses the above issues.

### BRIEF DESCRIPTION OF THE DRAWINGS

FIG. 1 is a block diagram illustrating aspects of a system in accordance herewith; and

FIG. 2 is a flow diagram illustrating aspects of a method in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Embodiments of the current invention use the capability of a standard mobile phone camera in conjunction with bar-coded devices to enable DIY installation and configuration of a security system. The bar codes are used to down-load an application to lead a home owner through the installation process, and subsequently to capture the bar-code serial numbers and device types as the system components are installed. For example, a “QR code” (abbreviation for Quick Response code) is a specific matrix barcode (or two-dimensional code) that is readable by dedicated QR barcode readers and camera telephones. The code consists of black modules arranged in a square pattern on a white background. The information encoded may be text, URL, or other data.

The configuration is loaded to the control panel via the mobile phone's communication capability (cellular or Wi-Fi) into the security panel (POTs, Wi-Fi or cellular). The application is designed to assist during the installation, to configure and then to guide the user through a test routine to ensure that installation was completed properly.

For example, in accordance with an aspect of a method, a barcoded element on a system carton downloads the installation application to a local communication device, such as a cellular phone. The application gives step-by-step instructions to guide a user through the process. Alternately, it would be possible to link to a web-site that gives instructions on installation, but does not down-load an application to the phone in order to enable end-to-end configuration and testing.

The control panel barcode is scanned—indicating capability and characteristics thereof. Then as each detector, or sensor element, is installed, a device barcode is scanned. For example, when instructed to install the front door contact of a security system, the contact barcode is scanned and the contact type and serial number are scanned into the phone.

If a device is not installed (e.g. no glass break detectors) then the user enters “no device”. Following completion of the installation, the user uploads the configuration to the control panel, perhaps by w-fi if the control panel is capable (determined during the first scan), or cellular communications. If connected via a cell phone, the configuration could be downloaded directly to the panel, particularly for a self-monitoring system. If a central station is involved in the monitoring of the system, then the cellular communication would go via a redirection server so that the configuration information would go to the central station database as well as the local panel.

The application then places the panel into test mode and the user is instructed to activate each sensor in a sequence which tests the quality of the installation.

If reporting of alarm events is to the mobile phone itself (for self-monitoring applications) then the event is returned to the phone through the entire end-to-end communication path. Reporting can also be to social networking or IM sites if required for self monitoring.

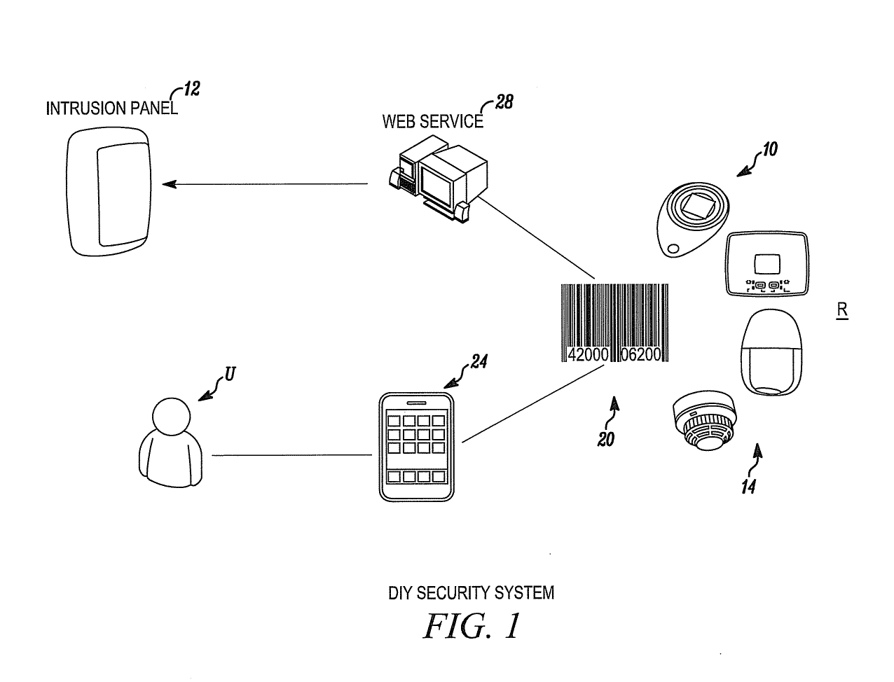

For example, FIG. 1 illustrates a kit 10 which when installed can function as a monitoring system 10-1 to monitor conditions at a region R. A control panel 12 and a plurality of different detectors, 14, such as motion detectors, smoke detectors, glass break detectors, door position detectors, or the like, all without limitation, can be shipped as the kit 10 with a 2D/3D barcode 20 printed on the outer carton thereof. A user, or installer, U scans the bar code 20 using a smart phone 24 that automatically connects to a web service 28 and guides the user U through the DIY installation process. The QR code on the outer carton or control panel itself could include the communication address and unique identifier for the system—e.g. a MAC ID, or cellular communication module identifier.

The end user U is prompted to capture a bar code on each of the security devices, or detectors 14 using a camera carried by the smart phone 24. All devices 14 have bar codes to identify the device type and a unique serial number. The user U then installs the devices, sensors, or detectors 14 in appropriate locations of a home or building to be monitored.

The configuration information for all detectors 14 is registered to the panel 12 from the smart phone 24 to the web service 28 and back to panel 12 via wireless communications systems, such as Ethernet/GSM/GPRS. The system 10-1 is then ready to use in monitoring the region R. If the web-server is local, e.g. in the control panel itself, then the communication could simply remain within the LAN and communication would be over the local wi-fi network.

The devices 14 can be in wired or wireless communication with the control panel 12. Those of skill will understand that the control panel 12 provides monitoring functions to respond to inputs received from the detectors or devices 14 indicative of conditions in the monitored region R. Panel 12 can also be in wired or wireless communication with other monitoring units, including the server 28 all without limitation.

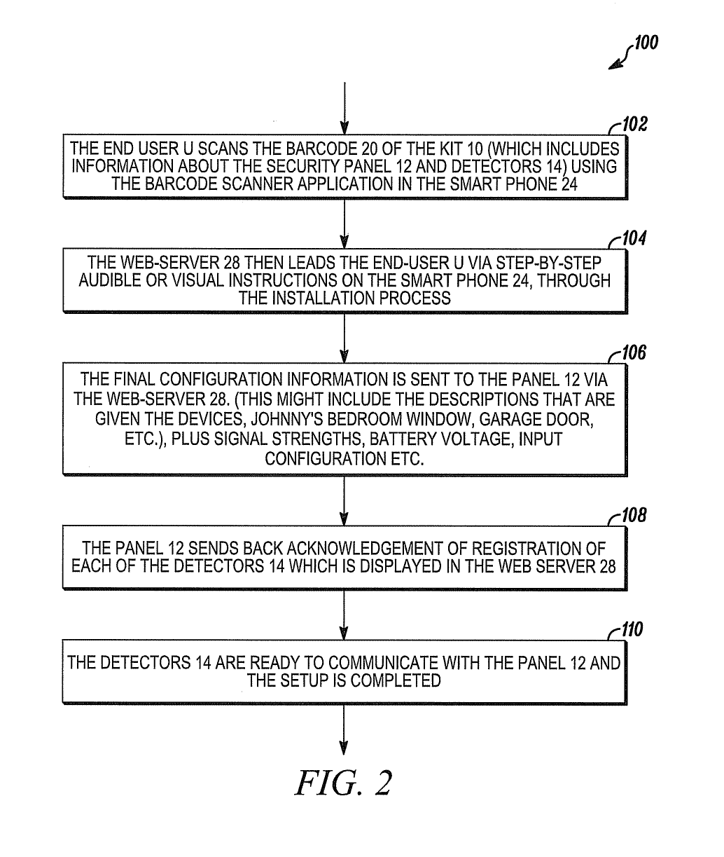

FIG. 2 illustrates an installation process 100. Initially, as at 102, the user U scans the barcode 20 using the smart phone 24. The server 28 then leads the user U via step-by-step instructions presented by the phone 24, visually, or audibly, or both through the process of installing the detectors 14, as at 104.

Final configuration information can be sent to the panel 12 as at 106. The panel 12 can respond, as at 108. The installed detectors 14 and control panel 12 can then interact, as at 110.

In summary, a kit based monitoring, or intrusion detecting system, can be installed by end users in easy steps supported by visual, or, verbal prompts, or instructions based on the capability of a standard mobile phone camera combined with bar-coded devices. As a result, a DIY installation and configuration of a residential or commercial security system can be successfully and efficiently carried out with reduced costs since a professional installer is not required to install the system.

The bar codes are used to down-load an application to lead a home owner through the installation process, and subsequently to capture the bar-code serial numbers and device types as the system components are installed. The configuration is loaded to the control panel via the mobile phone's communication capability (cellular or Wi-Fi) into the security panel (POTs, Wi-Fi or cellular). The application is designed to assist during the installation, to configure and then to guide the user through a test routine to ensure that installation has been completed properly.

By way of further example, the screen on the phone can provide a menu of questions and instructions to help the end-user with the installation. There may or may not be audible indications. In this regard, after scanning the panel, the user would get an instruction to scan the barcode on the first device—the phone would then say “you have scanned a glass break detector, this needs to be mounted within 10 feet of the glass that you are protecting, and facing the glass”, etc. After you mount the device please enter the description for the device (cursor would then allow entry of “front door glass”). The screen would then prompt scanning of the second device “you have scanned a low temperature detector”, etc.

It will be also understood that other machine readable coding configurations, apart from bar codes, come within the spirit and scope hereof. Also, the type of portable communications unit, such as unit 24 is not a limitation hereof.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An installation kit comprising:
at least one condition detector;
a control panel of a regional monitoring system; and
a coded element which specifies characteristics of the detector and the control panel wherein installation instructions can be downloaded to a selected communications device in response to the device sensing the coded element.

2. A kit as in claim 1 which includes circuitry that provides configuration information to the control panel.

3. A kit as in claim 1 which includes circuitry to establish communications between the detector and the control panel.

4. A kit as in claim 1 where the communications device comprises one of a cellular-type telephone, a personal digital assistant, a wireless lap top-type computer, or a wireless pad computer.

5. A kit as in claim 1 wherein, responsive to the selected communications device, a user can carry out a process to test the operation of the detector and the panel.

6. A kit as in claim 1 which includes a plurality of condition detectors, and wherein the communications device emits at least one of visual, or audible installation instructions for the installation thereof.

7. A kit as in claim 1 which includes a plurality of condition detectors, and where some of the detectors are different than others, and the communications device emits different visual, or audible installation instructions for different detectors.

8. A kit as in claim 1 wherein the communications device outputs the installation instructions visually, or audibly.

9. A kit as in claim 7 wherein the configuration information is transmitted to the control panel.

10. A method of installing a regional monitoring system comprising:
sensing information prestored on a coded element at a first location;
transmitting at least some of the sensed information to a receiver; and
returning installation instructions from the receiver to the first location, and responsive thereto, generating a sequence of installation instructions as at least one of an audio output, or a visual output.

11. A method as in claim 10 which includes providing installed system configuration information to a selected control unit.

12. A method as in claim 11 which includes providing a wireless two-way communications device and where sensing is carried out via the device.

13. A method as in claim 12 where sensing comprises barcode scanning which is carried out by executing a bar code scanning application running on the communications device.

14. A method as in claim 12 where transmitting is carried out wirelessly by a wireless communications device.

15. A method as in claim 12 where generating is carried out by the wireless communications device.

16. An installation kit comprising:
an assemblage including a regional monitoring control panel, and a plurality of coded peripheral environmental sensing units, wherein the members of the assemblage each include a communications interface with each unit interface having a wired, or wireless output port compatible with the communications interface of the control panel and with the control panel having an input/output port for communications via a computer network and where each member of the plurality carries a coded representation indicative of the characteristics of the respective member; and
a multi-dimensional coded element associated with the assemblage, where the element can be sensed and transmitted to an installation support service.

17. A kit as in claim 16 which includes circuitry to sense the coded element and to present visually, or audibly, instructions for installing the plurality of units in a selected region.

18. A kit as in claim 17 where the control panel includes circuitry to wirelessly receive and store the coded representations of the respective members.

19. A kit as in claim 18 wherein the control panel includes circuitry to test operation of each of the respective members for which coded representations have been received.
